(19) United States
(12) Patent Application Publication
(10) Pub. No.: US 2014/0049875 A1
(43) Pub. Date: Feb. 20, 2014

(54) NICKEL POWDER FOR INTERNAL ELECTRODE, METHOD OF PRODUCING THE SAME, AND MULTILAYER CERAMIC ELECTRONIC COMPONENT INCLUDING THE SAME

(71) Applicant: SAMSUNG ELECTRO-MECHANICS CO., LTD., Gyunggi-do (KR)

(72) Inventors: Gun Woo KIM, Gyunggi-do (KR); Hyo Sub KIM, Gyunggi-do (KR); Jeong Ryeol KIM, Gyunggi-do (KR); Chang Hoon KIM, Gyunggi-do (KR); Doo Young KIM, Gyunggi-Do (KR)

(73) Assignee: SAMSUNG ELECTRO-MECHANICS CO., LTD., Gyunggi-do (KR)

(21) Appl. No.: 13/670,139

(22) Filed: Nov. 6, 2012

(30) Foreign Application Priority Data
Aug. 16, 2012 (KR) 10-2012-0089523

(51) Int. Cl. C22C 19/03; H01G 4/12; H01G 4/005; B22F 9/16

(52) U.S. Cl. 361/321.2; 420/441; 75/343; 75/346

(57) ABSTRACT

There are provided a nickel powder for an internal electrode, synthesized by a vapor phase synthesis method using plasma, more particularly, a nickel powder for an internal electrode, having a favorable crystallite diameter and high density, a method of producing the same, and a multilayer ceramic electronic component including the same. According to the nickel powder for an internal electrode, the method of producing the same, and the multilayer ceramic electronic component including the same, a nickel powder having less impurities, a favorable crystallite diameter, and high density can be produced.

### CROSS-REFERENCE TO RELATED APPLICATIONS

This application claims the priority of Korean Patent Application No. 10-2012-0089523 filed on Aug. 16, 2012, in the Korean Intellectual Property Office, the disclosure of which is incorporated herein by reference.

### BACKGROUND OF THE INVENTION

1. Field of the Invention

The present invention relates to a nickel powder for an internal electrode, synthesized by a vapor phase synthesis method using plasma, and more particularly to a nickel powder for an internal electrode, having an excellent crystallite diameter and high density, a method of producing the same, and a multilayer ceramic electronic component including the same.

2. Description of the Related Art

As electronic devices have rapidly been miniaturized and multi-functionalized, a multilayer ceramic capacitor, an essential passive component of electronic devices, prominently tends to be ultra-thinned and have higher capacitance.

In general, a multilayer ceramic electronic component is manufactured by printing internal electrodes on ceramic dielectric sheets, laminating the ceramic dielectric sheets having the internal electrodes printed thereon, sintering them to form a ceramic body, and then forming external electrodes on external surfaces of the ceramic body.

As for the ceramic dielectric sheets having the internal electrodes printed thereon, the printed internal electrodes have a low sintering initiation temperature, and thus, initially start to be sintered at a lower temperature than the ceramic dielectric sheets.

As the result, the internal electrodes may be excessively sintered, whereby metal components agglomerate in a maldistributed condition. After the sintering, the internal electrode has discontinuous portions therein, and thus internal electrode continuity is remarkably deteriorated, resulting in a reduction in capacitance.

In order to solve the foregoing problems, a nickel fine-grain powder for an internal electrode is produced by a gas phase synthesis method using plasma, so that a nickel powder having less impurities and an excellent crystallite diameter, as compared to the related art, may be produced.

### RELATED ART DOCUMENTS

### Patent Documents

(Patent Document 1) Japanese Patent Laid-Open Publication No. 2004-300480

(Patent Document 2) Japanese Patent Laid-Open Publication No.

2004-292950

### SUMMARY OF THE INVENTION

An aspect of the present invention provides a nickel powder for an internal electrode, synthesized by a vapor phase synthesis method using plasma, and more particularly, a nickel powder for an internal electrode, having a favorable crystallite diameter and high density, and a method of producing the same, and a multilayer ceramic electronic component including the same.

According to an aspect of the present invention, there is provided a nickel powder for an internal electrode, the nickel powder comprising: a crystallite diameter of 55 to 100 nm, and an average particle diameter of 55 to 350 nm.

The nickel powder may have an impurity content of 500 ppm or less.

The nickel powder may have a density of 8.5 g/cm ³ or higher.

Here, an average number of crystallites included in the nickel powder may be 1 to 2.

According to another aspect of the present invention, there is provided a method of producing a nickel powder for an internal electrode of a multilayer ceramic electronic component, the method including: feeding a nickel raw material into a reactor; heating and evaporating the nickel raw material in an inert gas atmosphere; and condensing the evaporated nickel raw material to form a powder.

The powder may have an average particle diameter of 55 to 350 nm.

The average particle diameter of the powder may be controlled by varying kinds of inert gas or a temperature for evaporating the nickel raw material.

The heating and evaporating of the nickel raw material may be performed by using plasma.

The powder may have an impurity content of 500 ppm or less.

The powder may have a density of 8.5 g/cm³ or higher.

Here, an average number of crystallites included in the nickel powder may be 1 to 2.

According to another aspect of the present invention, there is provided a multilayer ceramic electronic component, including: a ceramic body; external electrodes formed on external surfaces of the ceramic body; and internal electrodes formed within the ceramic body, electrically connected to the external electrodes, and including a nickel powder having a crystallite diameter of 55 to 100 nm and an average particle diameter of 55 to 350 nm.

The nickel powder may have an impurity content of 500 ppm or less.

The nickel powder may have a density of 8.5 g/cm³ or higher.

Here, an average number of crystallites included in the nickel powder may be 1 to 2.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view schematically showing a multilayer ceramic capacitor according to an embodiment of the present invention;

FIG. 2 is a cross-sectional view taken along line B-B′ of FIG. 1;

FIG. 3 is a transmission electron microscopy (TEM) image of a nickel powder for an internal electrode according to an embodiment of the present invention;

FIG. 4 is a scanning electron microscopy (SEM) image of the nickel powder for an internal electrode according to the embodiment of the present invention;

FIG. 5 shows a nickel powder for an internal electrode, composed of a single crystallite, according to an embodiment of the present invention;

FIG. 6 shows a nickel powder for an internal electrode, composed of a plurality of crystallites, according to the embodiment of the present invention; and

FIG. 7 is a view showing a process of manufacturing a multilayer ceramic capacitor according to another embodiment of the present invention.

### DETAILED DESCRIPTION OF THE INVENTION

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

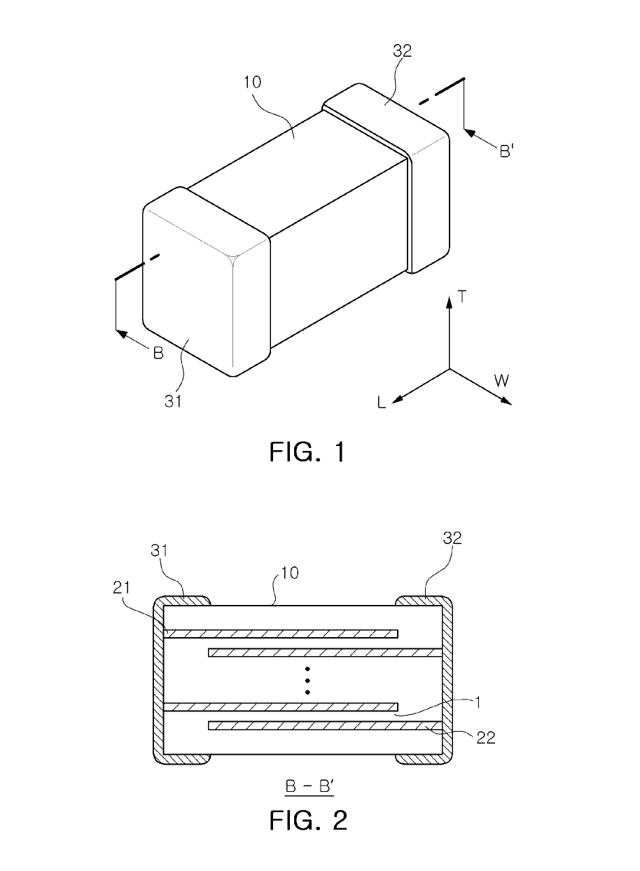

Referring to FIGS. 1 and 2, a multilayer ceramic electronic component according to an embodiment of the present invention may include: a ceramic body 10 including dielectric layers 1; a plurality of internal electrodes 21 and 22 facing each other with the dielectric layer 1 interposed therebetween in the ceramic body 10; and external electrodes 31 and 32 electrically connected to the plurality of internal electrodes 21 and 22.

Hereinafter, a multilayer ceramic electronic component according to an embodiment of the present invention, particularly, a multilayer ceramic capacitor, will be described, but the present invention is not limited thereto.

In the multilayer ceramic capacitor according to the embodiment of the present invention, ‘a length direction’, ‘a width direction’, and ‘a thickness direction’ are respectively defined by an ‘L’ direction, a ‘W’ direction, and a ‘T’ direction in FIG. 1. Here, the ‘thickness direction’ may be used to have the same meaning as a direction in which the dielectric layers are laminated, that is, a ‘lamination direction’.

According to the embodiment of the present invention, a raw material for forming the dielectric layer 1 is not particularly limited as long as sufficient capacitance can be obtained. For example, the raw material may be a barium titanate (BaTiO₃) powder.

As a material for forming the dielectric layer 1, various ceramic additives, organic solvents, plasticizers, binders, dispersants, or the like may be added to the powder, such as the barium titanate (BaTiO₃) powder, according to the object of the present invention.

The average particle diameter of a ceramic powder used in forming the dielectric layer 1 is not particularly limited, and may be controlled in order to achieve objects of the present invention, for example, to 400 nm or less.

A material forming the plurality of first and second internal electrodes 21 and 22 is not particularly limited, but may be, for example, a conductive paste including at least one of silver (Ag), lead (Pg), platinum (Pt), nickel (Ni), and copper (Cu).

In addition, the plurality of internal electrodes 21 and 22 may include a ceramic, and the ceramic is not particularly limited, but may be, for example, barium titanate (BaTiO₃).

External electrodes 31 and 32 maybe formed at an outside of the ceramic body 10 in order to form capacitance, and may be electrically connected to the plurality of first and second inner electrodes 21 and 22.

The external electrodes 31 and 32 may be formed of the same conductive material as the internal electrodes, but are not limited thereto. For example, the external electrodes 31 and 32 may be formed of copper (Cu) , silver (Ag) , nickel (Ni), or the like.

The external electrodes 31 and 32 may be formed by coating surfaces of the ceramic body 10 with a conductive paste prepared by adding a glass frit to the metal powder and then performing sintering thereon.

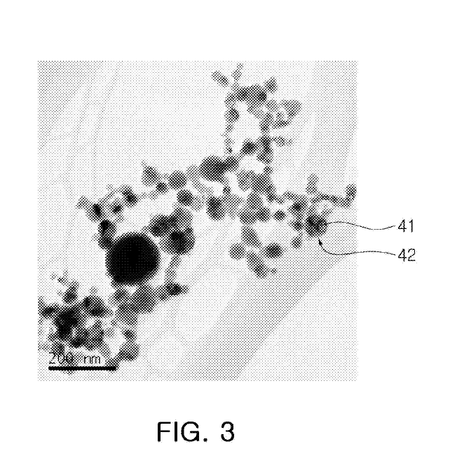

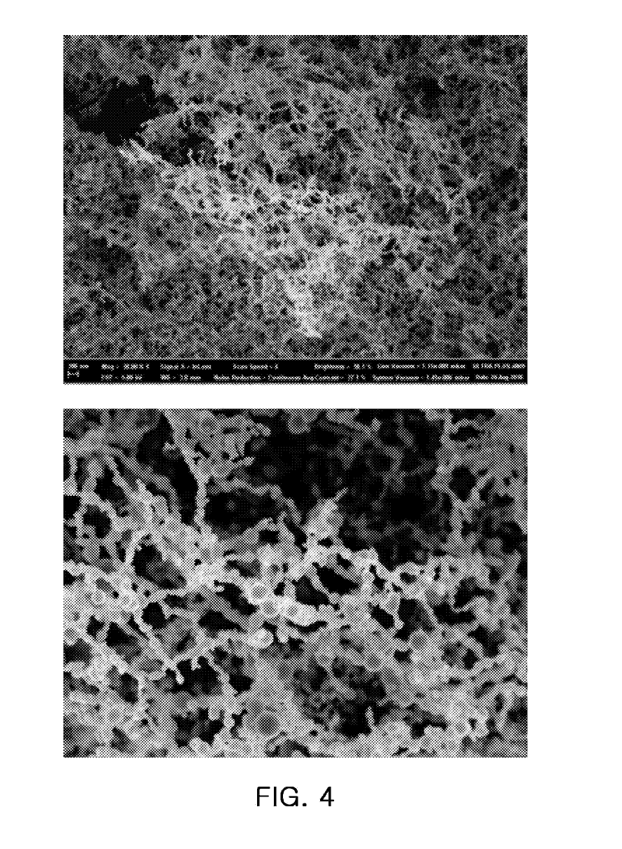

FIG. 3 is a transmission electron microscopy (TEM) image of the nickel powder for an internal electrode according to an embodiment of the present invention; and FIG. 4 is a scanning electron microscopy (SEM) image of the nickel powder for an internal electrode according to the embodiment of the present invention.

Referring to FIGS. 3 and 4, an internal electrode paste according to the embodiment of the present invention may contain a nickel powder 42 for an internal electrode in which a diameter of a crystallite 41 is 55 to 100 nm and an average particle diameter is 55 to 350 nm.

In general, methods of synthesizing the nickel powder 42 are classified into a liquid phase synthesis method and a gas phase synthesis method. The liquid phase synthesis method is advantageous in controlling the growth of particles, thereby facilitating the control of particle sizes, but has difficulty in constituting particles having high crystallinity.

Here, high crystallinity is determined by a crystallite size. A crystallite refers to an agglomerate that is recognized as a single crystal in a particle, and a single particle is composed of several crystallites.

A size (L) of the crystallite is measured by using XRD (X-ray diffraction), and an equation thereof is as follows.

L=Kλ/(βcosθ)

K: integer (0.9), λ: wavelength, β: half value breadth of a peak, θ: refraction angle.

That is, in the embodiment of the present invention, a nickel powder is synthesized by a gas phase synthesis method using plasma. Since the nickel powder has less impurities (500 ppm or less), and a favorable crystallite diameter (55 nm or larger) and thereby less particle defects, the nickel powder has characteristics similar to theory density (8.5 g/cm³ or higher). This nickel powder has fewer pores therein, and may allow improved continuity of the internal electrode.

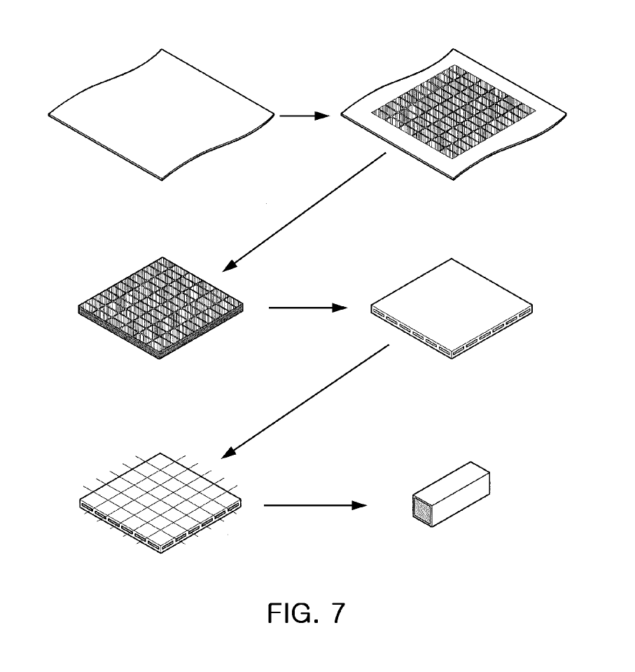

FIG. 7 is a view showing a process of manufacturing a multilayer ceramic capacitor according to another embodiment of the present invention.

Referring to FIG. 7, a method of manufacturing a multilayer ceramic electronic component according to another embodiment of the present invention may include: preparing ceramic green sheets including dielectric layers; forming internal electrode patterns on the ceramic green sheets by using a conductive paste for an internal electrode containing a conductive metal powder and a ceramic powder; laminating the ceramic green sheets having the internal electrodes formed thereon and then performing sintering thereon, to thereby form a ceramic body including a plurality of internal electrodes facing each other with the dielectric layer interposed therebetween therein.

In the method of manufacturing the multilayer ceramic electronic component according to another embodiment of the present invention, first, ceramic green sheets including a dielectric material may be prepared.

The ceramic green sheet may be fabricated by mixing the ceramic powder, the binder, and the solvent to prepare a slurry and molding the slurry into a sheet shape having a thickness of several μm using a doctor blade method.

Then, internal electrode patterns may be formed on the respective ceramic green sheets by using a conductive paste for an internal electrode, containing the conductive metal powder and the ceramic powder.

Then, the ceramic green sheets on which the internal electrode patterns are formed may be laminated and sintered, to thereby form a ceramic body including a plurality of internal electrodes disposed to face each other with the dielectric layer interposed therebetween.

A material for the conductive metal powder may be at least one of silver (Ag), lead (Pg), platinum (Pt), nickel (Ni), and copper (Cu).

In addition, a material for the ceramic powder may be barium titanate (BaTiO₃).

Descriptions of the same features as the multilayer ceramic electronic component according to the embodiment of the present invention as described above will be omitted.

Hereafter, the present invention will be described in detail with reference to examples, but is not limited thereto.

### Inventive Example

A process of synthesizing a nickel powder for an internal electrode of a multilayer ceramic capacitor according to the inventive example was as follows.

After RF-plasma (plasma formed when a current direction is changed in an RF period) ignition, a nickel raw material having a particle size of about 10 μm was fed into a reactor.

The nickel raw material was heated and evaporated under an inert gas atmosphere, and then the evaporated nickel raw material was condensed, to thereby form a nickel powder.

The conditions for RF-plasma ignition for synthesizing the nickel powder were shown in Table 1.

TABLE 1

| | | |
|---|---|---|
| Power | 60 | kW |
| Central gas | 30 | l/min(Ar) |
| Sheath gas | 100 | l/min(Ar + H²) |
| Quenching gas | 1500 | l/min(Ar) |
| Feeding rate | 10 | g/min |

The temperature in a quenching zone in an apparatus for controlling a particle growth is an important factor in particle crystallinity. The crystallite diameters of nickel powders respectively grown at three temperature profiles (100° C., 200° C., and 300° C.) in the quenching zone, which are obtained by controlling intensity of quenching gas, were analyzed through XRD analysis.

Changes in the crystallite diameter depending on the temperatures in the quenching zone, as analyzed above, were tabulated in Table 2 below.

TABLE 2

| | Temperature in quenching | Crystallite |
|---|---|---|
| Powder | zone | diameter |
| A | 100° C. | 25 nm |
| B | 200° C. | 32 nm |
| C | 300° C. | 58 nm |

An SEM image of the nickel powder synthesized when a temperature in the quenching zone was 300° C. is shown in FIG. 4, and a TEM image of the nickel powder is shown in FIG. 3.

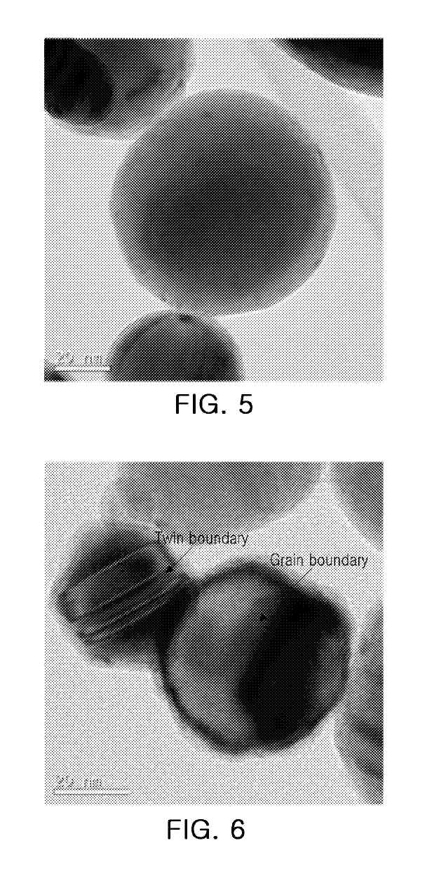

In addition, a nickel powder composed of a single crystallite is shown in FIG. 5, and a nickel powder composed of a plurality of crystallites including connection points (a twin boundary and a grain boundary) formed in a single particle is shown in FIG. 6.

Physical properties of Nickel powders A, B, and C synthesized according to the temperatures in the quenching zone were tabulated in Table 3.

TABLE 3

| | A | B | C |
|---|---|---|---|
| Temperature in | 100° C. | 200° C. | 300° C. |
| quenching zone | | | |
| Crystallite | 25 nm | 32 nm | 58 nm |
| diameter (Dc) | | | |
| Carbon content | 139 ppm | 223 ppm | 180 ppm |
| Density | 8.31 g/cm³ | 8.48 g/cm³ | 8.72 g/cm³ |
| Average | 78 nm (Rmax | 80 nm (Rmax | 81 nm (Rmax |
| particle | 297 nm) | 320 nm) | 310 nm) |
| diameter (Da) | | | |
| Da/Dc | 3.12 | 2.50 | 1.40 |

When Dc denotes a crystallite diameter of the powder measured by using XRD and Da denotes an average particle diameter of the powder measured from the SEM image, Da/Dc means an average number of crystallites included in a single powder.

That is, it can be seen that powder A is composed of approximately 3.12 crystallites, powder B is composed of approximately 2.50 crystallites, and powder C is composed of approximately 1.40 crystallites.

A paste for an internal electrode of a multilayer ceramic capacitor was prepared by adding ethyl cellulose as a binder and a terpineol solvent to the powder. The paste was thinly coated on the film, and then was dried under vacuum conditions in a state in which inner bubbles are removed. Density of a paste dry film was measured and then compared with a theory density value.

In addition, a ceramic slurry was prepared by adding a polyvinyl butyral-based binder and an organic solvent such as ethanol to a barium titanate based ceramic raw powder and then wet-mixing them. Then, ceramic green sheets were molded by applying a doctor blade method. In addition, the paste having conductivity was screen-printed on the ceramic green sheets, to thereby form internal electrodes.

After that, several ceramic green sheets on which conductive paste films were printed were laminated in such a manner that sides of the ceramic green sheets, to which the conductive paste films are withdrawn, were alternately positioned. Then, the laminated sheets were compressed and integrated, and then cut to have appropriate sizes, to thereby obtain a green chip.

Then, the green chip was heat-treated at a temperature of 250° C. in the nitrogen atmosphere and subjected to a debindering treatment, and then sintered in a reduction atmosphere of 1000˜1200° C., thereby obtaining a sintered chip. Internal electrode continuity of the sintered chip was measured.

The measured characteristics of the paste and the sintered chip employing the powders synthesized according to the temperatures in the quenching zone were tabulated in Table 4.

TABLE 4

| | | Electrode |
|---|---|---|
| | Density of paste dry film/ | continuity of |
| Powder | theory density of dry film | sintered chip |
| A | 93% | 90% |
| B | 94% | 91% |
| C | 98% | 96% |

A high crystallinity powder having a small number of, large-sized crystallites had high density due to a reduction in connection points within the powder, which resulted in increasing density of the paste dry film when the powder was used to prepare a paste. In addition, it was confirmed that the increase in density of the dry film led to an improvement in electrode continuity of the sintered chip.

As set forth above, in accordance with the nickel powder for an internal electrode of a multilayer ceramic electronic component, the method of producing the same, and the multilayer ceramic electronic component including the same according to the embodiments of the present invention, a nickel powder having fewer impurities, a favorable crystallite diameter, and high density can be produced.

While the present invention has been shown and described in connection with the embodiments, it will be apparent to those skilled in the art that modifications and variations can be made without departing from the spirit and scope of the invention as defined by the appended claims.

What is claimed is:

1. A nickel powder for an internal electrode, the nickel powder comprising:
a crystallite diameter of 55 to 100 nm, and
an average particle diameter of 55 to 350 nm.

2. The nickel powder of claim 1, wherein the nickel powder has an impurity content of 500 ppm or less.

3. The nickel powder of claim 1, wherein the nickel powder has a density of 8.5 g/cm³ or higher.

4. The nickel powder of claim 1, wherein an average number of crystallites included in the nickel powder is 1 to 2.

5. A method of producing a nickel powder for an internal electrode of a multilayer ceramic capacitor, the method comprising:
feeding a nickel raw material into a reactor;
heating and evaporating the nickel raw material in an inert gas atmosphere; and
condensing the evaporated nickel raw material to form a powder.

6. The method of claim 5, wherein the powder has an average particle diameter of 55 to 350 nm.

7. The method of claim 5, wherein the average particle diameter of the powder is controlled by varying kinds of inert gas or a temperature for evaporating the nickel raw material.

8. The method of claim 5, wherein the heating and evaporating of the nickel raw material is performed by using plasma.

9. The method of claim 5, wherein the powder has an impurity content of 500 ppm or less.

10. The method of claim 5, wherein the powder has a density of 8.5 g/cm³ or higher.

11. The method of claim 5, wherein an average number of crystallites included in the nickel powder is 1 to 2.

12. A multilayer ceramic electronic component, comprising:
a ceramic body;
external electrodes formed on external surfaces of the ceramic body; and
internal electrodes formed within the ceramic body, electrically connected to the external electrodes, and including a nickel powder having a crystallite diameter of 55 to 100 nm and an average particle diameter of 55 to 350 nm.

13. The multilayer ceramic electronic component of claim 12, wherein the nickel powder has an impurity content of 500 ppm or less.

14. The multilayer ceramic electronic component of claim 12, wherein the nickel powder has a density of 8.5 g/cm³ or higher.

15. The multilayer ceramic electronic component of claim 12, wherein an average number of crystallites included in the nickel powder is 1 to 2.
